(19) United States
(12) Patent Application Publication
(10) Pub. No.: US 2008/0224611 A1
(43) Pub. Date: Sep. 18, 2008

(54) ELECTRODE SHEET, METHOD OF MANUFACTURING THE ELECTRODE SHEET AND PLASMA DISPLAY PANEL HAVING THE ELECTRODE SHEET

(76) Inventors: Yong-shik Hwang, Suwon (KR); Won-ju Yi, Suwon (KR); Kyoung-doo Kang, Suwon (KR); Jong-woo Choi, Suwon (KR); Byoung-min Chun, Suwon (KR); Jae-ik Kwon, Suwon (KR)

Correspondence Address: CHRISTIE, PARKER & HALE, LLP, PO BOX 7068, PASADENA, CA, 91109-7068, US

(21) Appl. No.: 12/048,155

(22) Filed: Mar. 13, 2008

(30) Foreign Application Priority Data
Mar. 16, 2007 (KR) 10-2007-0026196

(51) Int. Cl. H01J 9/02; H01J 17/49

(52) U.S. Cl. 313/586; 445/47; 445/14

(57) ABSTRACT

An electrode sheet, a method of manufacturing the electrode sheet, and a plasma display panel having the electrode sheet. The electrode sheet includes: a plurality of electrodes arranged at substantially constant distances apart, each of the electrodes having a discharge space in its central region; an electrode line for connecting the electrodes along a first direction; and a dielectric enclosing the electrodes and the electrode line and connecting the electrodes along a second direction, wherein the electrodes and the electrode line are composed of magnesium (Mg), and the dielectric is composed of magnesium oxide (MgO).

### CROSS-REFERENCE TO RELATED APPLICATION

This application claims priority to and the benefit of Korean Patent Application No. 10-2007-0026196, filed on Mar. 16, 2007, in the Korean Intellectual Property Office, the entire content of which is incorporated herein by reference.

### BACKGROUND

1. Field of the Invention

The present invention relates to an electrode sheet, a method of manufacturing the electrode sheet, and a plasma display panel having the electrode sheet

2. Discussion of Related Art

In recent years, there is an increasing need for a large flat panel display. As such, there are active attempts to develop a plasma display panel (PDP) having a large panel that can be easily manufactured.

Generally, a plasma display panel includes a plurality of pixels arranged in a matrix. The pixels are selected by address discharge using an image data, and a phosphor is excited by ultraviolet rays generated during a continuous sustain discharge procedure to emit visible light. In this case, the number of the sustain discharges is a critical factor to determine a light-emitting luminance and a luminous efficiency of the plasma display panel because the plasma display panel displays gray levels required for displaying an image by controlling the number of the sustain discharges.

In addition, another factor that determines the light-emitting luminance and the luminous efficiency of the plasma display panel is the structure of pixels. For example, a DC surface emitting structure has a low luminous efficiency. Therefore, an AC surface discharge structure has been proposed to improve the luminous efficiency.

The AC surface discharge structure is designed to discharge electric charges between an upper electrode and a lower electrode, wherein the upper electrode is used as a scan electrode and the lower electrode is used as an address electrode.

In this AC plasma display panel, the upper electrode and the lower electrode is generally formed of silver (Ag), and protective layers are formed on surfaces of the upper electrode and the lower electrode. The protective layers have dielectric properties to protect the electrodes from damages, to insulate the electrodes, and/or to enhance emission efficiency of secondary electrons.

For example, an electrode layer is formed by printing a paste of silver (Ag) on a glass substrate with a thickness ranging from several tens to 100 μm, and then patterned to form an upper electrode or a lower electrode. A dielectric is formed with PbO—B₂O₃—SiO₂ on a surface of the upper electrode or lower electrode, and then magnesium oxide (MgO) is deposited on the dielectric to form a protective layer.

However, it is difficult to uniformly form a plurality of dielectric layers on the electrode surface having a thickness ranging from several tens to 100 μm, productivity is low due to the complicated manufacturing process, and/or voltage resistance characteristics are deteriorated due to field focusing.

### SUMMARY OF THE INVENTION

Aspects of embodiments of the present invention are directed toward an electrode sheet capable of simplifying a manufacturing process, a method of manufacturing the electrode sheet, and a plasma display panel having the electrode sheet.

Other aspects of embodiments of the present invention are directed toward an electrode sheet having improved physical properties such as abrasion resistance, heat resistance and voltage resistance, a method of manufacturing the electrode sheet, and a plasma display panel having the electrode sheet.

Other aspects of embodiments of the present invention are directed toward an electrode sheet utilizing a magnesium (Mg) sheet, a method of manufacturing the electrode sheet, and a plasma display panel having the electrode sheet.

An embodiment of the present invention provides an electrode sheet for a plasma display panel, the electrode sheet including: a plurality of electrodes arranged at substantially constant distances apart, each of the electrodes having a discharge space in its central region; an electrode line for connecting the electrodes along a first direction; and a dielectric enclosing the electrodes and the electrode line and connecting the electrodes along a second direction, wherein the electrodes and the electrode line are composed of magnesium (Mg), and the dielectric is composed of magnesium oxide (MgO).

Another embodiment of the present invention provides a method of manufacturing an electrode sheet for a plasma display panel, the method including: preparing a magnesium (Mg) sheet having a substantially constant thickness; patterning the magnesium sheet to form a plurality of electrodes, an electrode line, and a bridge, the electrodes being arranged at substantially constant distances apart, each of the electrodes having a discharge space in its central region, the electrode line connecting the electrodes along a first direction to each other, and the bridge connecting the electrodes along a second direction to each other; and oxidizing the patterned magnesium sheet with the substantially constant thickness to form a dielectric on surfaces of the electrodes and the electrode line, the dielectric comprising magnesium oxide (MgO).

Another embodiment of the present invention provides a plasma display panel. The plasma display includes: a first substrate; a second substrate facing the first substrate; a first electrode sheet composed of a plurality of first electrodes, a first electrode line, and a first dielectric, the first electrodes being arranged on one surface of the first substrate and each of the first electrodes having a discharge space, the first electrode line connecting the first electrodes along a first direction, and the first dielectric enclosing the first electrodes and the first electrode line and connecting the first electrodes along a second direction; a second electrode sheet composed of a plurality of second electrodes, a second electrode line, and a second dielectric, the second electrodes being arranged on one surface of the second substrate to correspond to the discharge spaces of the first electrodes, the second electrode line connecting the second electrodes along the second direction, and the second dielectric enclosing the second electrodes and the second electrode line and connecting the second electrodes along the first direction; and a phosphor layer on the first substrate exposed through one of the discharge spaces, wherein the first electrodes, the first electrode line, the second electrodes, and/or the second electrode line are composed of magnesium (Mg), and the first dielectric and/or the second dielectric are composed of magnesium oxide (MgO).

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a cross-sectional view showing a plasma display panel according to a first embodiment of the present invention.

FIG. 2A and FIG. 2B are plan views showing a first electrode sheet as shown in FIG. 1.

FIG. 3A and FIG. 3B are plan views showing a second electrode sheet as shown in FIG. 1.

FIG. 4 is a cross-sectional view showing a plasma display panel according to a second embodiment of the present invention.

FIG. 5A is a plan view showing a first electrode sheet as shown in FIG. 4.

FIG. 5B is a plane view showing a second electrode sheet as shown in FIG. 4.

### DESCRIPTION OF CERTAIN PARTS IN THE FIGURES

| | |
|---|---|
| 11, 111: upper substrate | 20, 120: first electrode sheet |
| 21, 121: first electrode | 22, 122: first electrode line |
| 23, 123, 145: discharge space | 24, 43, 124, 143: bridge |
| 25, 44, 125, 144: dielectric | 31, 131: lower substrate |
| 40, 140: second electrode sheet | 41, 141: second electrode |
| 42, 142: second electrode line | 51, 151, 152: phosphor layer |
| 161: spacer layer | |

### Detailed Description

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

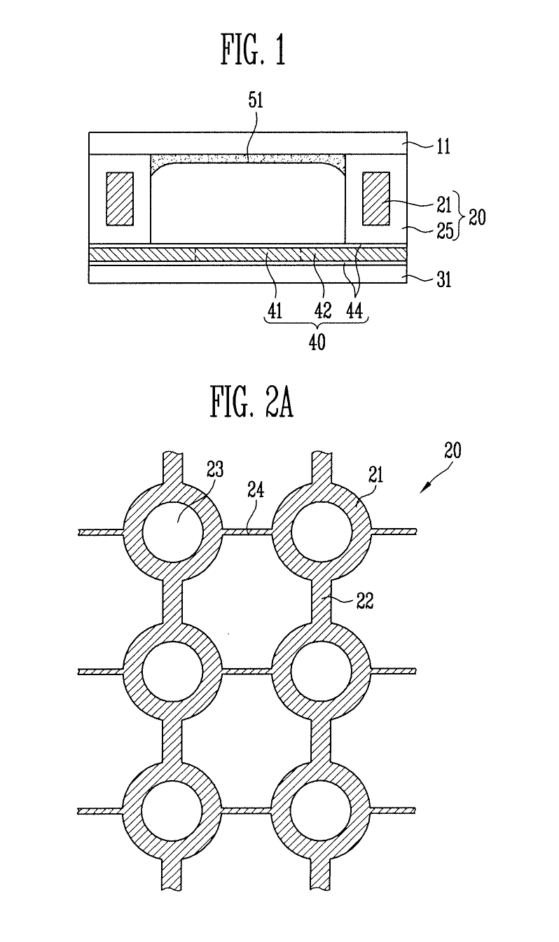

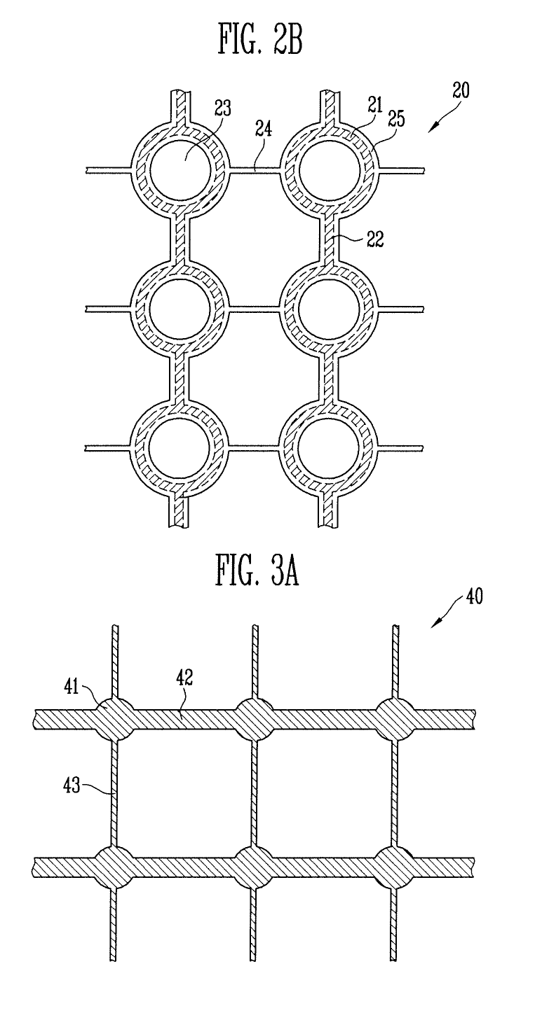

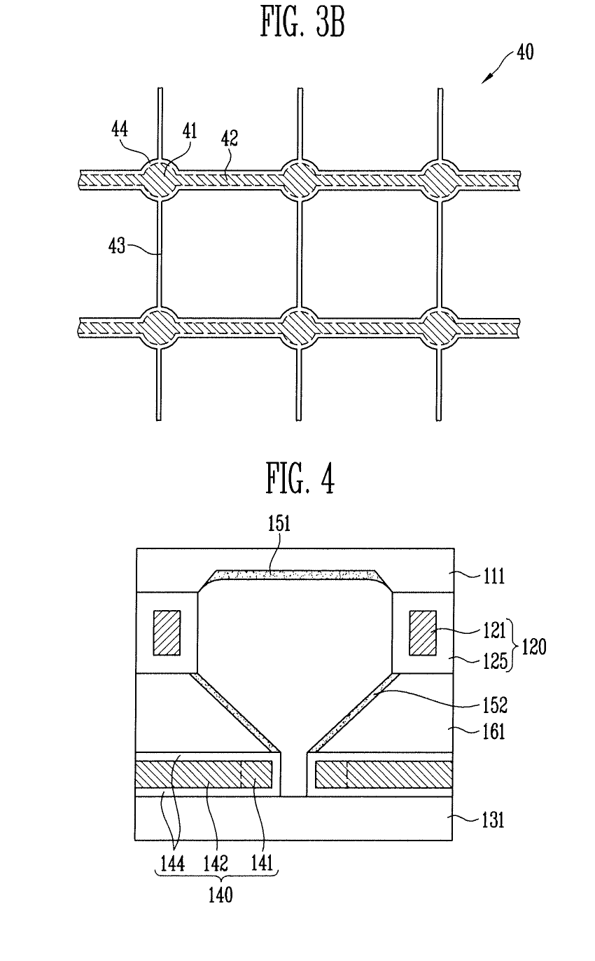

FIG. 1 is a cross-sectional view showing a plasma display panel according to a first embodiment of the present invention. In FIG. 1, one pixel is schematically shown for convenience purposes. FIG. 2A and FIG. 2B and FIG. 3A and FIG. 3B are plan views showing a first electrode sheet and a second electrode sheet.

Referring to FIG. 1 and FIG. 2B, a first electrode sheet 20 is arranged on one surface of a first substrate 11. The first electrode sheet 20 includes a plurality of first electrodes 21, a first electrode line 22, and a dielectric 25. The first electrodes 21 are formed at constant (or substantially constant) distances apart, and each of the first electrodes 21 has a discharge space 23 formed in its central region. The first electrode line 22 connects the first electrodes 21 arranged in (or along) a first direction, and the dielectric 25 encloses (or encases or encapsulates) the first electrodes 21 and the first electrode line 22 and connects the first electrodes 21 arranged in (or along) a second direction.

Referring to FIG. 1 and FIG. 3B, a second electrode sheet 40 is arranged on one surface of a second substrate 31 and spaced apart from the first substrate 11 (at a constant or substantially constant distance) so that the second substrate 31 and the first substrate 11 can face each other. The second electrode sheet 40 includes a plurality of second electrodes 41, a second electrode line 42, and a dielectric 44. The second electrodes 41 are arranged to correspond to the discharge spaces 23 of the first electrodes 21. The second electrode line 42 connects the second electrodes 41 arranged in (or along) the second direction, and the dielectric 44 encloses (or encases or encapsulates) the second electrodes 41 and the second electrode line 42 and connects the second electrodes 41 arranged in (or along) the first direction.

Also, a phosphor layer 51 is formed on the first substrate 11 and exposed to one of second electrodes 41 through one of the discharge spaces 23, and a mixed inert gas such as He+Xe, Ne+Xe and He+Xe+Ne is injected into the closed discharge space 23 as a gas for forming a plasma. Here, the discharge space 23 may be sealed with a barrier rib composed of the dielectrics 25 and 44, or sealed with a separately formed barrier rib.

FIG. 2A and FIG. 2B are plan views showing a method for manufacturing the first electrode sheet 20 as shown in FIG. 1.

In one embodiment, a magnesium (Mg) sheet having a constant thickness is prepared. The magnesium sheet is patterned using photolithography as shown in FIG. 2A to form the plurality of first electrodes 21, the first electrode line 22, and a bridge 24. The first electrodes 21 are formed at constant (or substantially constant) distances apart, and each of the first electrodes 21 has the discharge space (or spherical or circular discharge space) 23 formed in its central region. The first electrode line 22 connects the first electrodes 21 arranged in the first direction to each other, and the bridge 24 connects the first electrodes 21 arranged in the second direction to each other.

If the magnesium sheet with the constant (or substantially constant) thickness, patterned as shown in FIG. 2B, is oxidized using an electrochemical process, surfaces of the first electrodes 21 and the first electrode line 22 are oxidized to form the dielectric 25 composed of magnesium oxide (MgO), as shown in FIG. 2B. If the first electrodes 21 and the first electrode line 22 are formed to have a wider width than that of the bridge 24, and the bridge 24 is subject to an oxidation process for its complete oxidation, then a dielectric 25 composed of magnesium oxide (MgO) is formed on the surfaces of the first electrodes 21 and the first electrode line 22, and simultaneously the bridge 24 is completely converted into magnesium oxide (MgO). Accordingly, the first electrodes 21 arranged in the second direction are structurally coupled but electrically separated by utilizing the bridge 24 converted into magnesium oxide (MgO).

FIG. 3A and FIG. 3B are plan views showing a method for manufacturing the second electrode sheet 40 as shown in FIG. 1.

In one embodiment, a magnesium (Mg) sheet having a constant (or substantially constant) thickness is prepared. The magnesium sheet is patterned using a photolithography as shown in FIG. 3B to form the plurality of second electrodes 41, the second electrode line 42 and a bridge 43. The second electrodes 41 are arranged to correspond to the discharge spaces 23 of the first electrodes 21. The second electrode line 42 connects the second electrodes 41 arranged in the second direction to each other, and the bridge 43 connects the second electrodes 41 arranged in the first direction to each other.

If the magnesium sheet with the constant (or substantially constant) thickness, patterned as shown in FIG. 3A, is oxidized, then surfaces of the second electrodes 41 and the second electrode line 42 are oxidized to form the dielectric 44 composed of magnesium oxide (MgO), as shown in FIG. 3B. If the second electrodes 41 and the second electrode line 42 are formed to have a wider width than that of the bridge 43, and the bridge 43 is subject to an oxidation process for its complete oxidation, then a dielectric 44 composed of magnesium oxide (MgO) is formed on the surfaces of the second electrodes 41 and the second electrode line 42, and simultaneously the bridge 43 is completely converted into magnesium oxide (MgO). Accordingly, the second electrodes 41 arranged in the first direction are structurally coupled but electrically separated by utilizing the bridge 43 converted into magnesium oxide (MgO).

The first electrode sheet 20 and the second electrode sheet 40, prepared as described above, may be attached to the first (or upper) substrate 11 and the second (or lower) substrate 31 using an adhesive. Also, in this embodiment, the first electrodes 21 and the second electrode 41 have a circular (or spherical) structure, but the present invention is not limited thereto, and may be varied into various other suitable shapes.

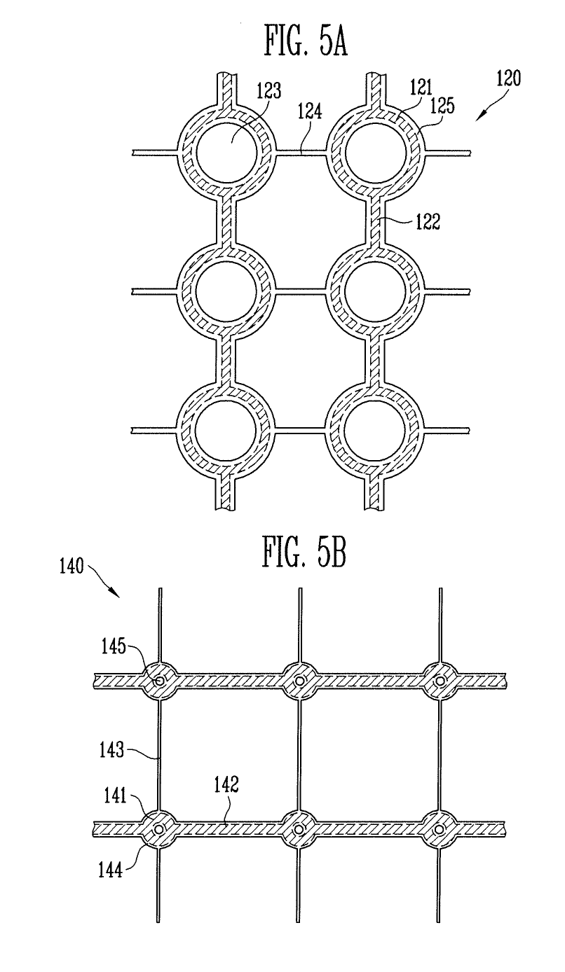

FIG. 4 is a cross-sectional view showing a plasma display panel according to a second embodiment of the present invention. In FIG. 4, one pixel is schematically shown for convenience purposes. FIG. 5A and FIG. 5B are plan views showing a first electrode sheet and a second electrode sheet.

Referring to FIG. 4 and FIG. 5A, a first electrode sheet 120 is arranged on one surface of a first substrate 111. The first electrode sheet 120 includes a plurality of first electrodes 121, a first electrode line 122 and a dielectric 125. The first electrodes 121 are arranged at constant (or substantially constant) distances, and each of the first electrodes 121 has a discharge space 123 formed in its central region. The first electrode line 122 connects the first electrodes 121 arranged in (or along) a first direction, and the dielectric 125 encloses (or encases or encapsulates) the first electrodes 121 and the first electrode line 122 and connects the first electrodes 121 arranged in (or along) a second direction.

Referring to FIG. 4 and FIG. 5B, a second electrode sheet 140 is arranged on one surface of a second substrate 131 and spaced apart from the first substrate 111 (at a constant or substantially constant distance) so that the second substrate 131 and the first substrate 111 can face each other. The second electrode sheet 140 includes a plurality of second electrodes 141, a second electrode line 142, and a dielectric 144. The second electrodes 141 are arranged to correspond to the discharge spaces 123 of the first electrode 121. In addition, each of the second electrodes 141 has a discharge space 145 formed in its central region. The second electrode line 142 connects the second electrodes 141 arranged in (or along) the second direction, and the dielectric 144 encloses (or encases or encapsulates) the second electrodes 141 and the second electrode line 142 and connects the second electrodes 141 arranged in (or along) the first direction.

Also, a spacer layer 161 is formed between the first electrode sheet 120 and the second electrode sheet 140, the spacer layer 161 having a hole formed in a region corresponding to one of the discharge spaces 123. Also, phosphor layers 151 and 152 are formed on the first (or upper) substrate 111 exposed through one of the discharge spaces 123, and on a side wall of the spacer layer 161 exposed through the hole of the spacer layer 161. Here, a groove having a constant depth may be formed on the upper substrate 111, and the phosphor layer 151 may be formed inside the groove. The spacer layer 161 may space the first electrode sheet 120 and the second electrode sheet 140 at a constant (or substantially constant) distance apart from each other, and simultaneously may be used as a barrier rib. A mixed inert gas such as He+Xe, Ne+Xe and He+Xe+Ne is injected into the closed discharge space 123 as a gas for forming a plasma. Here, the discharge space 123 may be sealed with a barrier rib composed of the dielectrics 125 and 144, or sealed with a separately formed barrier rib.

Referring to FIG. 5A, the first electrode sheet 120, as configured as described above, may be prepared using the following method.

In one embodiment, a magnesium (Mg) sheet having a constant (or substantially constant) thickness is patterned using a photolithography to form a plurality of first electrodes 121, a first electrode line 122, and a bridge 124. The first electrodes 121 are arranged at constant (or substantially constant) distances apart, and each of the first electrodes 121 has the discharge space (or spherical or circular discharge space) 123 formed in its central region. The first electrode line 122 connects the first electrodes 121 arranged in the first direction to each other, and the bridge 124 connects the first electrodes 121 arranged in the second direction to each other.

If the patterned magnesium sheet with the constant (or substantially constant) thickness is oxidized, then surfaces of the first electrodes 121 and the first electrode line 122 are oxidized to form the dielectric 125 composed of magnesium oxide (MgO). If the first electrodes 121 and the first electrode line 122 are formed to have a wider width than that of the bridge 124, and the bridge 124 is subject to an oxidation process for its complete oxidation, then a dielectric 125 composed of magnesium oxide (MgO) is formed on the surfaces of the first electrodes 121 and the first electrode line 122, and simultaneously the bridge 124 is completely converted into magnesium oxide (MgO). Accordingly, the first electrodes 121 arranged in the second direction are structurally coupled but electrically separated by utilizing the bridge 124 converted into magnesium oxide (MgO).

Referring to FIG. 5B, the second electrode sheet 140, as configured as described above, may also be prepared in the same (or substantially the same) manner as in FIG. 5A.

In one embodiment, a magnesium (Mg) sheet having a constant (or substantially constant) thickness is patterned using a photolithography to form the plurality of second electrodes 141, the second electrode line 142 and a bridge 143. The second electrodes 141 are arranged to correspond to the discharge spaces 123 of the first electrodes 121. Each of the second electrodes has the discharge space (or spherical or circular discharge space) 145 formed in its central region. The second electrode line 142 connects the second electrodes 141 arranged in the second direction to each other, and the bridge 143 connects the second electrodes 141 arranged in the first direction to each other.

If the patterned magnesium sheet with a constant (or substantially constant) thickness is oxidized, then surfaces of the second electrode 141 and the second electrode line 142 are oxidized to form the dielectric 144 composed of magnesium oxide (MgO). If the second electrodes 141 and the second electrode line 142 are formed to have a wider width than that of the bridge 143, and the bridge 143 is subject to an oxidation process for its complete oxidation, then a dielectric 144 composed of magnesium oxide (MgO) is formed on the surfaces of the second electrode 141 and the second electrode line 142, and simultaneously the bridge 143 is completely converted into magnesium oxide (MgO). Accordingly, the second electrode 141 arranged in the first direction are structurally coupled but electrically separated by utilizing the bridge 143 converted into magnesium oxide (MgO).

The first electrode sheet 120 and the second electrode sheet 140, prepared as described above, may be attached to the first (or upper) substrate 111 and the second (or lower) substrate 131 using an adhesive. Also, in this embodiment, the first electrodes 121 and the second electrode 141 have a circular (or spherical) structure, but the present invention is not limited thereto, and may be varied into various other suitable shapes.

In order to drive a plasma display panel as configured as in the first and second embodiments, a pulse signal (that may be predetermined) is applied respectively to the first electrodes 21 and/or 121 and the second electrodes 41 and/or 141 of the pixels that are selected through a plurality of first electrode lines 22 and/or 122 and a plurality of second electrode lines 42 and/or 142, respectively. For example, a scan signal is applied to the first electrodes 21 and/or 121, and an address signal is applied to the second electrodes 41 and/or 141. Accordingly, phosphors 51, 151 and/or 152 are excited by ultraviolet rays generated by the sustain discharge between the first electrodes 21 and/or 121 and the second electrodes 41 and/or 141, thereby emitting the visible light.

As described above, in an embodiment of the present invention, a plurality of electrodes and an electrode line are formed, the electrodes and the electrode line being structurally coupled using a magnesium (Mg) sheet, and a dielectric composed of magnesium oxide (MgO) is formed on surfaces of the electrodes and the electrode line through an oxidation process, and simultaneously some of the electrodes and the electrode line are electrically separated from each other.

In addition, a method according to an embodiment of the present invention is relatively easy and simple, as compared to conventional methods, because the surfaces of the electrodes and the electrode line are oxidized to form a dielectric. Also, the method does require a step of forming a separate protective layer and can freely utilize any suitable phosphor layers according to its colors since the dielectric is formed of magnesium oxide (MgO). Moreover, the electrodes composed of magnesium and the dielectric composed of magnesium oxide may be useful to improve electrical characteristics and reliability because they have stable connection structure and electrical characteristics, a surface of the dielectric composed of magnesium oxide has a strong corrosion and abrasion resistance and excellent physical properties such as insulation, heat resistance and voltage resistance.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electrode sheet for a plasma display panel, the electrode sheet comprising:
a plurality of electrodes arranged at substantially constant distances apart, each of the electrodes having a discharge space in its central region;
an electrode line for connecting the electrodes along a first direction; and
a dielectric enclosing the electrodes and the electrode line and connecting the electrodes along a second direction,
wherein the electrodes and the electrode line are composed of magnesium (Mg), and the dielectric is composed of magnesium oxide (MgO).

2. A method of manufacturing an electrode sheet for a plasma display panel, the method comprising:
preparing a magnesium (Mg) sheet having a substantially constant thickness;
patterning the magnesium sheet to form a plurality of electrodes, an electrode line, and a bridge, the electrodes being arranged at substantially constant distances apart, each of the electrodes having a discharge space in its central region, the electrode line connecting the electrodes along a first direction to each other, and the bridge connecting the electrodes along a second direction to each other; and
oxidizing the patterned magnesium sheet with the substantially constant thickness to form a dielectric on surfaces of the electrodes and the electrode line, the dielectric comprising magnesium oxide (MgO).

3. The method of manufacturing an electrode sheet for a plasma display panel according to claim 2, wherein the electrode line is patterned to have a wider width than that of the bridge.

4. The method of manufacturing an electrode sheet for a plasma display panel according to claim 2, wherein the bridge is subject to an oxidation process for its complete oxidation.

5. The method of manufacturing an electrode sheet for a plasma display panel according to claim 2, further comprising:
preparing a second magnesium (Mg) sheet having a substantially constant thickness;
patterning the second magnesium sheet to form a plurality of second electrodes, a second electrode line, and a second bridge, the second electrodes being arranged at substantially constant distances apart to correspond to the discharge spaces, the second electrode line connecting the second electrodes along the second direction to each other, and the second bridge connecting the second electrodes along the first direction to each other; and
oxidizing the patterned second magnesium sheet with the substantially constant thickness to form a second dielectric on surfaces of the second electrodes and the second electrode line, the second dielectric comprising magnesium oxide (MgO).

6. The method of manufacturing an electrode sheet for a plasma display panel according to claim 5, wherein the second electrode line is patterned to have a wider width than that of the second bridge.

7. The method of manufacturing an electrode sheet for a plasma display panel according to claim 5, wherein the second bridge is subject to an oxidation process for its complete oxidation.

8. A plasma display panel, comprising:
a first substrate;
a second substrate facing the first substrate;
a first electrode sheet composed of a plurality of first electrodes, a first electrode line, and a first dielectric, the first electrodes being arranged on one surface of the first substrate and each of the first electrodes having a discharge space, the first electrode line connecting the first electrodes along a first direction, and the first dielectric enclosing the first electrodes and the first electrode line and connecting the first electrodes along a second direction;
a second electrode sheet composed of a plurality of second electrodes, a second electrode line, and a second dielectric, the second electrodes being arranged on one surface of the second substrate to correspond to the discharge spaces of the first electrodes, the second electrode line connecting the second electrodes along the second direction, and the second dielectric enclosing the second electrodes and the second electrode line and connecting the second electrodes along the first direction; and
a phosphor layer on the first substrate exposed through one of the discharge spaces,
wherein the first electrodes, the first electrode line, the second electrodes, and/or the second electrode line are composed of magnesium (Mg), and the first dielectric and/or the second dielectric are composed of magnesium oxide (MgO).

9. The plasma display panel according to claim 8, wherein the first electrode line and the second electrode line cross each other.

10. The plasma display panel according to claim 8, further comprising an adhesive, wherein the first electrode sheet is attached to the first substrate by the adhesive.

11. The plasma display panel according to claim 8, further comprising a spacer layer between the first electrode sheet and the second electrode sheet and having a hole formed in a region corresponding to one of the discharge spaces.

12. The plasma display panel according to claim 8, wherein a discharge space is in a central region of each of the second electrodes.

13. The plasma display panel according to claim 8, wherein the first electrodes, the first electrode line, the second electrodes, and the second electrode line are composed of magnesium (Mg).

14. The plasma display panel according to claim 8, wherein the first dielectric and the second dielectric are composed of magnesium oxide (MgO).

15. The plasma display panel according to claim 8, wherein the first electrodes, the first electrode line, the second electrodes, and the second electrode line are composed of magnesium (Mg), and the first dielectric and the second dielectric are composed of magnesium oxide (MgO).
